(19) United States
(12) Patent Application Publication
(10) Pub. No.: US 2005/0196742 A1
(43) Pub. Date: Sep. 8, 2005

(54) System and method for data analysis and presentation

(76) Inventors: Jonathan David Harber, New York, NY (US); Daniel Eytan Ginsberg, Brooklyn, NY (US); R. Harris Ferrell IV, San Francisco, CA (US); Harold C. Doran, Alexandria, VA (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/792,393

(22) Filed: Mar. 4, 2004

(51) Int. Cl. G09B 13/02

(52) U.S. Cl. 434/362; 434/350; 434/322

(57) ABSTRACT

Embodiments of the invention relate to the graphical display of data at a summary level. In such embodiments, icons are used, where a visual representation of each of the icons represents a feature of underlying data. A user can select an icon in a summary data view to navigate to more detailed data associated with the icon. Embodiments of the invention also provide methods for calculating and using a student proficiency ranking index for use in comparing, aggregating, or otherwise processing heterogeneous test data.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The invention relates generally to the field of data processing. In particular, but not by way of limitation, the invention relates to systems and methods for processing and presenting data to a user at a summary level based on the more detailed underlying data.

### BACKGROUND OF THE INVENTION

Systems and methods are generally known for aggregating data into a summary format. Moreover, methods are generally known for presenting summarized data into a tabular or graphical format. Known systems and methods for summarizing data have many disadvantages, however. For example, in known approaches, manual intervention may be required to convert the underlying data to the graphical summary. In addition, in conventional approaches, the summarized information may not be usable where particular details of interest are not disclosed in the summary. Further, in many cases, there is not a straightforward method for navigating between the summary information and more detailed information that is of interest to a user.

In many fields of data processing, the data represent test results. Systems and methods are known to compare the results where a test is uniformly administered. However, where different testing instruments are used, the content tests, and even the scale used in scoring, may vary. It is difficult to compare data collected by such heterogeneous testing methods using conventional approaches.

In one respect, what is needed is a more robust technique for summarizing information in a way that provides the user with both the high level summary and an ability to easily navigate between higher and lower levels of data abstraction. In another respect, what is needed is an improved method for comparing the results of heterogeneous testing instruments so that such individual test results can be compared, and so that the test results can then be viewed in the aggregate.

### BRIEF SUMMARY OF THE INVENTION

Embodiments of the invention relate to the graphical display of data at a summary level. In such embodiments, icons are used, where a visual representation of each of the icons represents a feature of underlying data. A user can select an icon in a summary data view to navigate to more detailed data associated with the icon. Embodiments of the invention also provide methods for calculating and using a student proficiency ranking index for use in comparing, aggregating, or otherwise processing heterogeneous test data.

In one respect, embodiments of the invention provide a method for presenting data, including: displaying a first table, the first table including at least one column, at least one row, and at least one icon, each of the at least one icons associated with one of the at least one column and one of the at least one row, at least one of the icons being numbered; determining whether a user selects a numbered one of the at least one icons; and if the user selects a numbered one of the at least one icons, displaying a second table based on the column and the row associated with the selected one of the at least one icon.

In another respect, embodiments of the invention provide a method for displaying assessment data, including: displaying a first portion of the assessment data for at least one subject area and at least one demographic category, displaying including rendering a plurality of icons, each of the plurality of icons associated with one of the at least one subject area and one of the at least one demographic category, at least one of the plurality of icons incorporating a number associated with a quantity of students; determining whether a user selects a numbered icon; and if the user selects a numbered icon, displaying a second portion of the assessment data corresponding to the quantity of students.

In another respect, embodiments of the invention provide a method for displaying student performance data, the data including for each of a plurality of subjects an indication of whether the student has achieved proficiency, the data organized into cells, each cell including data for a plurality of students, including: determining the total number of non-proficient students associated with the cell; determining whether the total number of proficient students is less than a predetermined threshold for the cell; if the total number of non-proficient students is less than the predetermined threshold, rendering a first icon for the cell; and if the total number of non-proficient students is not less than the predetermined threshold, rendering a second icon for the cell, the second icon having at least one numeric character superimposed thereon.

In another respect, embodiments of the invention provide a method for calculating a first student proficiency ranking index for a first student, on a first test, in a first subject, in a first grade, including: determining a raw test score on the first test; converting the raw test score to a first observed scale score; determining a lower bound scale score for proficiency for the first test; determining a standard deviation for the first test; subtracting the lower bound scale score for proficiency for the first test from the first observed scale score to produce a first difference value; and dividing the first difference value by the standard deviation for the first test to produce a first standard deviation unit.

Exemplary embodiments of the invention shown in the drawings are described below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the scope and spirit of the invention as expressed in the claims.

### BRIEF DESCRIPTION OF THE DRAWINGS

Embodiments of the invention are described with reference to the following drawings, wherein:

FIG. 1 is a schematic diagram of a hierarchy of administrative data, according to an embodiment of the invention;

FIG. 2 is a schematic diagram of a hierarchy of data presentations, according to an embodiment of the invention;

FIG. 3 is an illustration of a data presentation, according to an embodiment of the invention;

FIG. 4 is an illustration of a data presentation, according to an embodiment of the invention;

FIG. 5 is an illustration of a data presentation, according to an embodiment of the invention; and

FIG. 6 is an illustration of a data presentation, according to an embodiment of the invention.

FIG. 7 is an illustration of a data presentation, according to an embodiment of the invention;

FIG. 8 is a flow diagram of a process for presenting data, according to an embodiment of the invention;

FIG. 9 is a flow diagram of a process for presenting data, according to an embodiment of the invention;

FIG. 10A is a schematic diagram of a data index, according to an embodiment of the invention;

FIG. 10B is a graphical illustration of a data distribution, according to an embodiment of the invention;

FIG. 11 is an illustration of a data presentation, according to an embodiment of the invention;

FIG. 12 is an illustration of a data presentation, according to an embodiment of the invention;

FIG. 13 is an illustration of a data presentation, according to an embodiment of the invention;

FIG. 14 is a block diagram of a functional architecture, according to an embodiment of the invention.

### DETAILED DESCRIPTION OF THE INVENTION

To illustrate features of the invention, this section discloses exemplary embodiments related to the processing of student proficiency data, generally, and compliance with statutory or other performance targets in particular.

The No Child Left Behind (NCLB) Act requires schools to demonstrate Adequate Yearly Progress (AYP) in core academic subject areas. Initially, the core areas are Math and English Language Arts (ELA), later extending to Science and Social Studies. Student assessment data must be disaggregated into subgroups such as ethnicity, gender, socio-economic status, special education, migrant, and limited English proficiency (LEP) status. Each subgroup within a school must achieve the AYP goals set by the state, generally measured as a minimum percentage of students at or above the proficient cut point (although other metrics, such as individual student progress may also be required either in the alternative, or in combination with, subgroup proficiency percentage targets). If any single cohort does not meet the minimum threshold of proficient students, the entire school will be deemed to have not achieved adequate yearly progress. Schools failing to achieve AYP goals face consequences that grow increasingly harsh each year, eventually resulting in a managerial takeover of the institution after five years of not achieving AYP. Understanding patterns in student performance is key to making strategic decisions that will increase academic achievement to meet AYP targets.

This section first provides an overview of how academic data may be summarized and disaggregated. Next, several exemplary data presentation formats are presented, and processes are disclosed for generating such presentations, and for allowing a user to navigate between alternative data views. Methods are then disclosed for calculating and using a student proficiency ranking index. The disclosure concludes with a few alternative presentation formats and a brief description of a functional architecture for performing the embodiments described herein. Sub-headings are used below for organizational convenience, but do not necessarily limit the disclosure of any particular feature to any particular section of this specification. We begin with the overview.

Overview

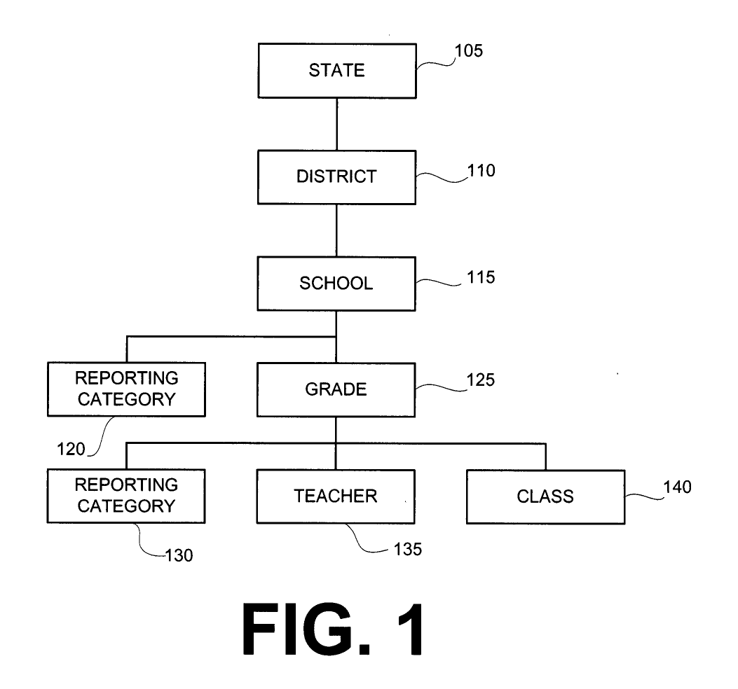

FIG. 1 is a schematic diagram of a hierarchy of data reporting levels, according to an embodiment of the invention. As shown in FIG. 1, such a hierarchy may include, for example, a state level 105, a district level 110, a school level 115, a reporting category level 120, a grade level 125, a reporting category level 130, a teacher category level 135 and a class category level 140. For instance, a principal at the school level 115 may desire to view administrative data by reporting category level 120 or by grade level 125. Similarly, data at the grade level 125 may be variously viewed by reporting category level 130, by teacher category level 135 or by class level 140. Reporting categories may be, for example, information related to AYP categories described above.

Alternative parsing is also possible. For example, data at the school level 115 or the grade level 125 may be further divided according to subject area. In addition, while data may be thought as being disaggregated from a higher level of the hierarchy to a lower level of the hierarchy, it may also be advantageous to aggregate data from a lower level of the hierarchy to a higher level of the hierarchy.

Exemplary Data Presentation Formats

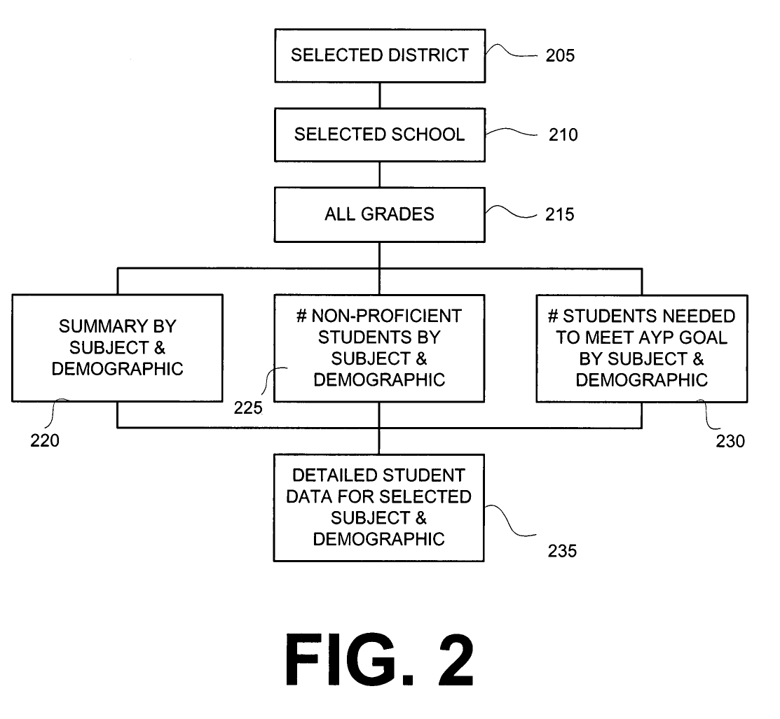

FIG. 2 is a schematic diagram of a hierarchy of data presentations, according to an embodiment of the invention. FIG. 2 represents a more detailed hierarchy for particular reports for all grades or a selected school. As shown in FIG. 2, a selected school 210 of a district 205 is viewing data for all grades 215. Data may be viewed as a summary by subject and demographic at level 220, showing the number of non-proficient students by subject and demographic at level 225, or showing the number of students needed to meet an AYP goal by subject and demographic at level 230. Moreover, from any of the levels 220, 225, or 230, detailed student data for a selected subject and demographic is available at level 235.

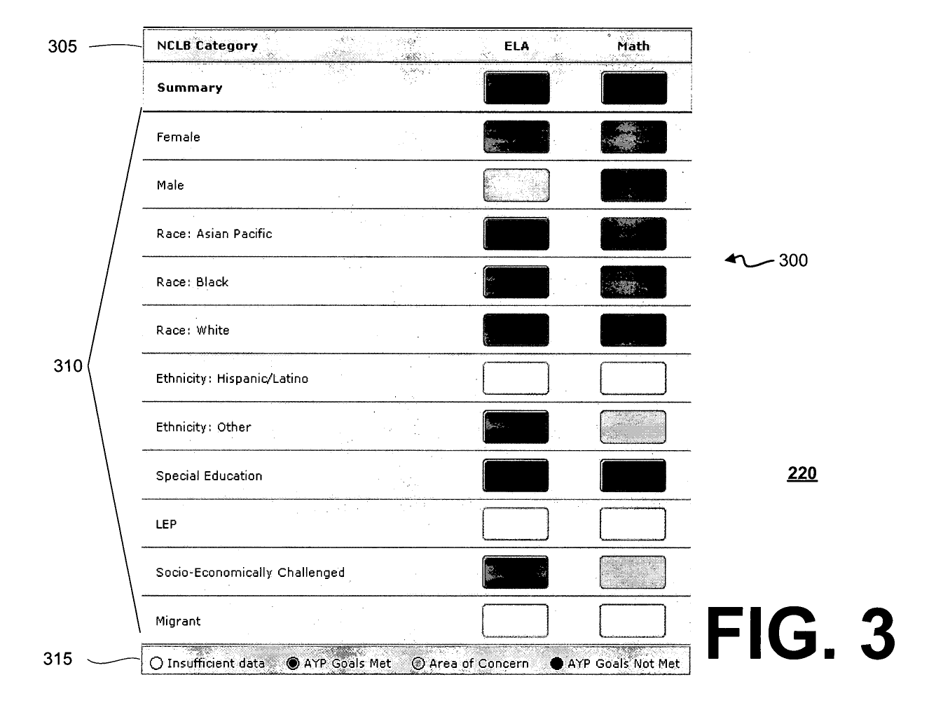

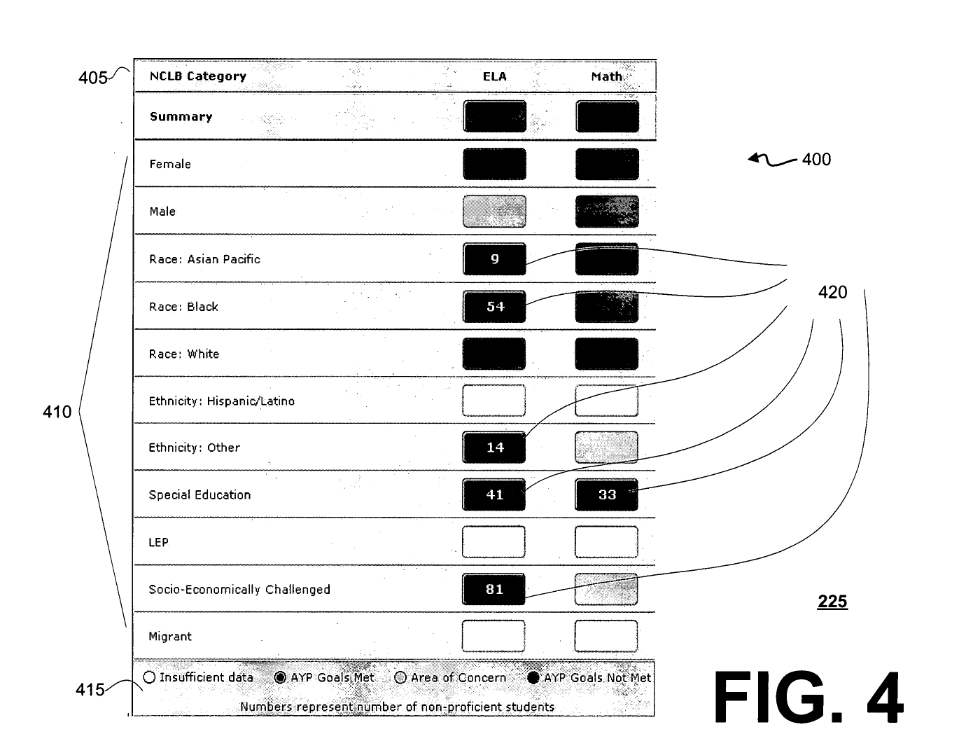

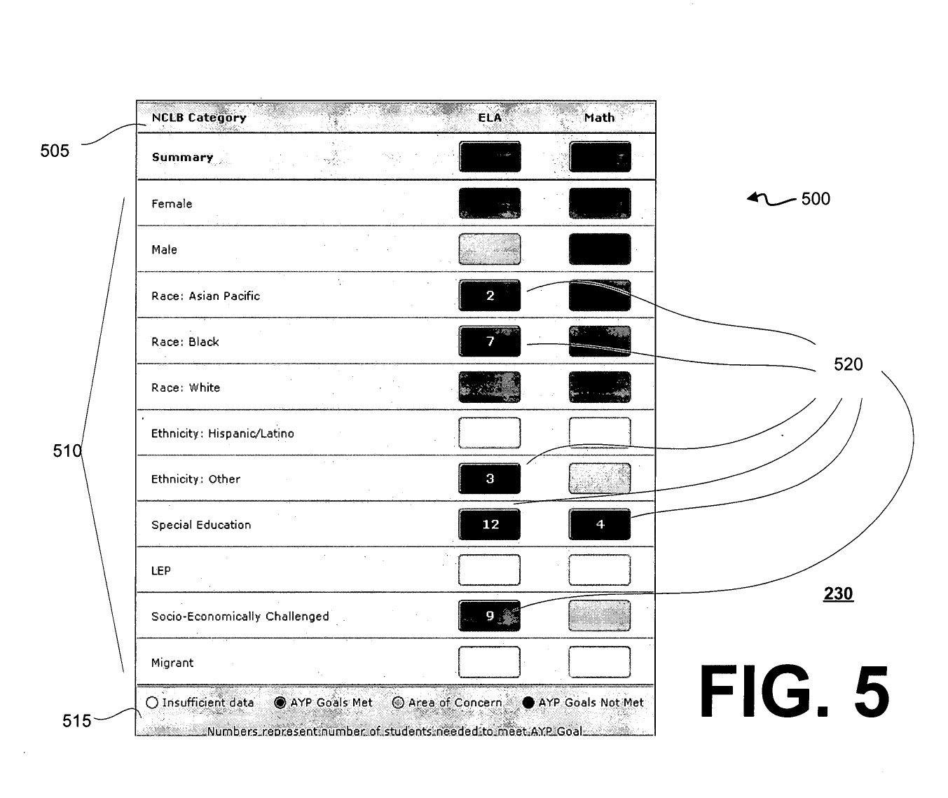

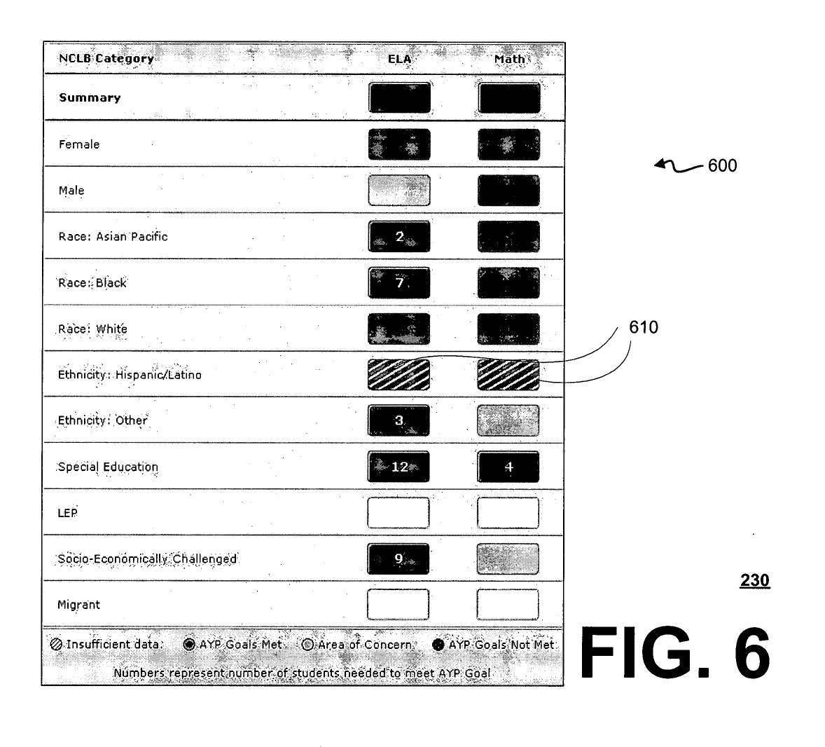

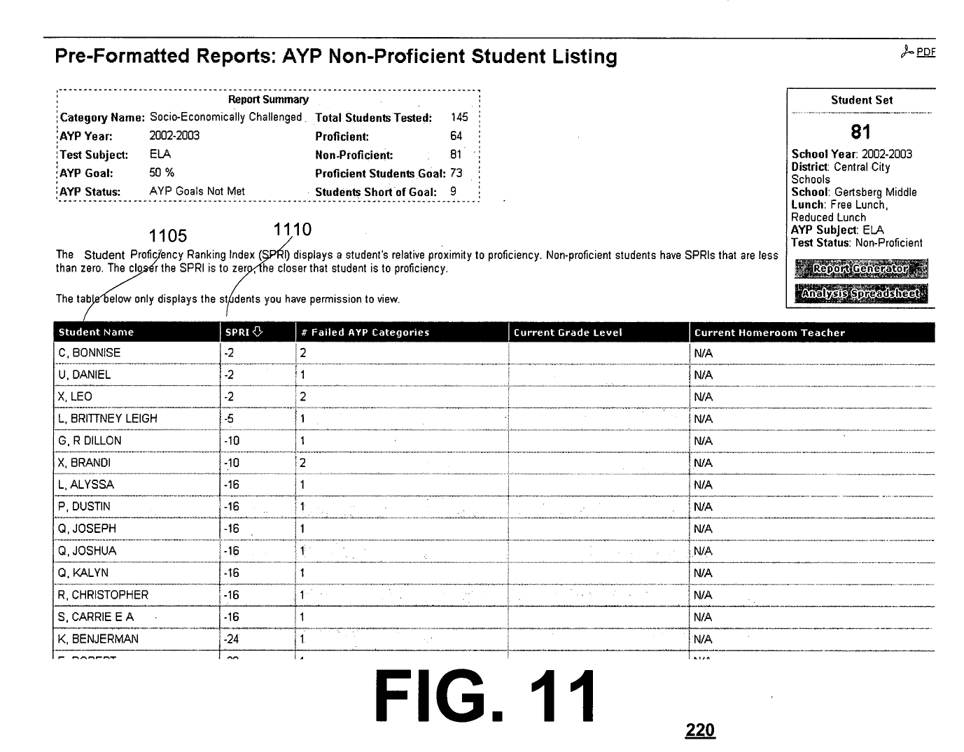

Exemplary data presentation formats are provided for each of the reporting levels 220, 225, 230, and 235. In particular, a presentation for data at level 220 is illustrated in FIG. 3, a presentation for data at level 225 is illustrated in FIG. 4, a presentation for data at level 230 is illustrated in FIGS. 5 and 6, and a presentation for data at level 235 is illustrated in FIG. 11.

FIG. 3 is an illustration of a data presentation, according to an embodiment of the invention. As shown in FIG. 3, a table 300 includes a column heading 305 indicating category and subject, rows 310 indicating AYP category, and a legend 315. As used herein, a cell is each portion of the table 300 uniquely identified by a particular column and row.

As shown in FIG. 3, each of the cells may be represented by rectangles, and each of the rectangles may be color coded, shaded or otherwise differentiated based on the underlying data. For example, legend 315 may indicate that green is used to indicate that AYP goals are met, yellow is used to indicate an area of concern (e.g., that AYP goals are only marginally met), red is used to indicate that AYP goals are not been met, and white is used to indicate insufficient data.

In alternative embodiments of this and other presentation formats described herein, geometric objects other than rectangles may be used. Other icons may also be used. As used herein, and icon is broadly defined as any graphic symbol whose form is suggestive of the underlying data or function. A geometric object is a type of icon. In addition, in alternative embodiments, the shape, size, and/or other characteristic of the geometric object or other icon may be varied to indicate performance against predetermined targets. In embodiments of the invention, icons also provide a linking function, which will be described in more detail below with reference to exemplary embodiments.

FIG. 4 is an illustration of a data presentation, according to an embodiment of the invention. As shown in FIG. 4, a table 400 includes a column heading 405 indicating category and subject, rows 410 indicating AYP category, and a legend 415. In addition, FIG. 4 indicates that certain cells 420 have numbers superimposed. As indicated in legend 415, the numbers in cells 420 represent the number of non-proficient students, as measured against predetermined AYP category targets.

FIG. 5 is an illustration of a data presentation, according to an embodiment of the invention. As shown in FIG. 5, a table 500 includes a column heading 505 indicating category and subject, rows 510 indicating AYP category, and a legend 515. In addition, FIG. 5 indicates that certain cells 520 are numbered. As indicated in legend 515, the numbers in cells 520 represent the number of students that must be converted from non-proficient status to proficient status, in order to meet the predetermined AYP target.

The data presentations illustrated in FIGS. 3, 4, and 5 can be for the same underlying data set. For purposes of comparison, consider the cell designated by AYP category “Asian Pacific” and subject area “ELA.” FIG. 3 indicates that AYP goals are not met; FIG. 4 indicates that nine students are not proficient; and FIG. 5 indicates that at least two Asian Pacific students must become proficient in ELA for the predetermined AYP targets to be met.

FIG. 6 is an illustration of a data presentation, according to an embodiment of the invention. The data presentation in FIG. 6 is substantially similar to the data presentation in FIG. 5, except that in Table 600, cells 610 are hatched to represent performance against a target other than proficiency. Use of hatching, or other visual queue, may be advantageous, for example, to identify a statistically insufficient amount of data. In other embodiments, hatching may be used to measure performance against other secondary criteria not related to proficiency.

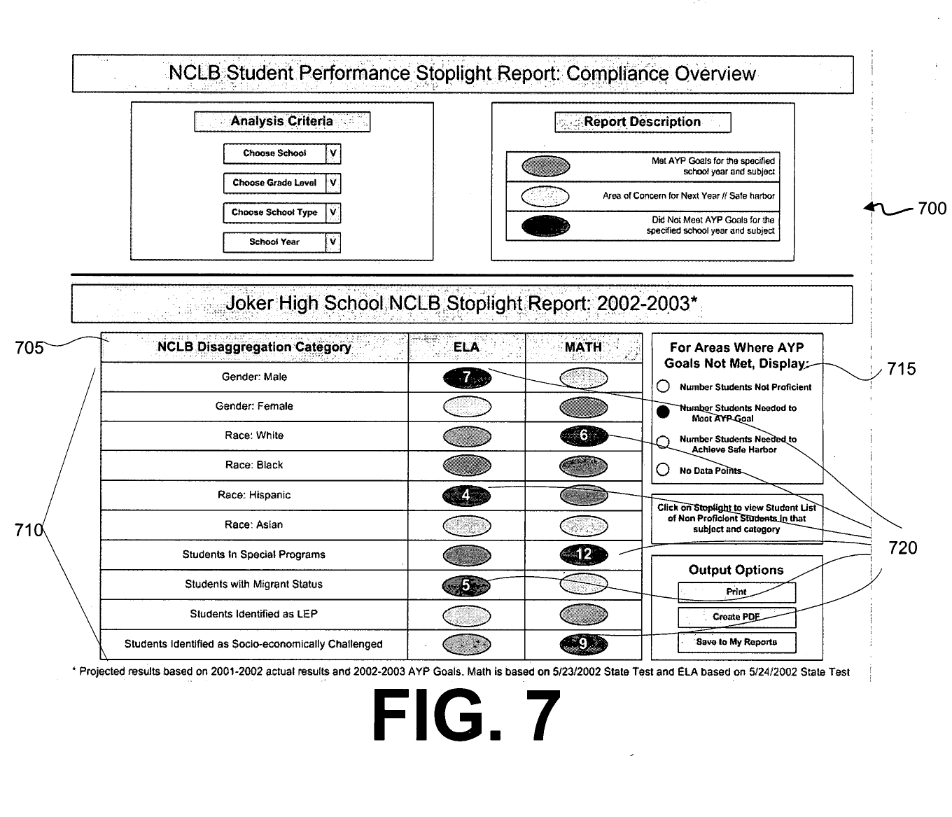

FIG. 7 is an illustration of a data presentation, according to an embodiment of the invention. As shown in FIG. 7, a table 700 includes a column heading 705 indicating category and subject, rows 710 indicating AYP category, a menu 715, and numbered cells 720. FIG. 7 illustrates that a user may navigate between data representations 220, 225, and 230 via menu 715. In the illustrated view, menu 715 indicates the numbers in cells 720 indicate the number of students needed to meet the AYP goal. FIG. 7 also illustrates that ovals may be used, among other geometric shapes or other icons, as previously described.

Any of the data presentations illustrated in FIGS. 3-7 may be generated for display on a personal computer monitor. In the alternative, or in combination, the presentations may be formatted for printing, using methods understood in the art. Further, in any and all embodiments described herein, where icons are numbered, the numbers could alternatively represent percentages of students in a group, a quantity of students that are non-proficient, or a quantity of students that would need to move from non-proficiency to proficiency to meet AYP goals or other predetermined target, or other parameter, according to application requirements.

Methods for Displaying Data

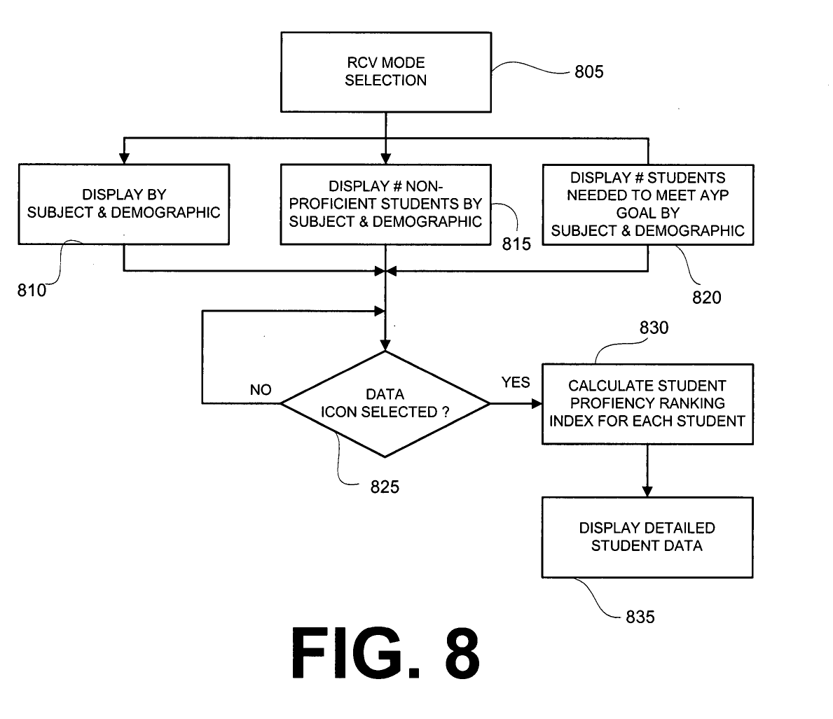

FIG. 8 is a flow diagram of a process for displaying data, according to an embodiment of the invention. As shown in FIG. 8, the process receives a mode selection in step 805. Next, according to the received mode selection, the process advances to one of steps 810 to display a summary by subject and demographic, 815 to display a summary with the number of non-proficient students by subject and demographic, or step 820 to display a summary with the number of students needed to meet an AYP goal by subject and demographic. After any one of steps 810, 815, and 820, the process determines whether a data icon associated with a particular cell has been selected by a user in conditional step 825. Where the result of conditional step 825 is negative, the process repeats the determination in step 825, perhaps after a delay (not shown). Where the result of conditional step 825 is in the affirmative, the process advances to step 830 to calculate a student proficiency ranking index for each student in the selected cell. Finally, the process advances to step 835 to display detailed student data associated with the selected cell.

The mechanism for advancing a user from a summary view (e.g., generated by one of display steps 810, 815, or 820 to a more detailed view (e.g., generated by step 835) can be, for example, a hyperlink associated with an icon which is implemented with conventional software programming techniques. A system executing the process may receive a user selection via a mouse click, touch screen, or other user-input device. The more detailed data that is generated through the click-through or other selection may be based on additional external criteria and may change from user session to user session. For example, in one embodiment, students must be actively enrolled in the district and school to be included in the resulting list: if a student is withdrawn, data related to the withdrawn student would be excluded from the more detailed report, and data related to the withdrawn student could be omitted from calculations used in generating the more detailed report.

Many variations to the process illustrated in FIG. 8 are possible. For example, determination step 825 may only be responsive to selection of an icon having a number superimposed thereon. In addition, there may be more, less, or other display choices than those depicted in steps 810, 815, and 820. Further, calculation step 830 is an optional step. For example, in one embodiment, the detailed student data displayed in step 835 does not utilize a student proficiency ranking index; in another embodiment, the student proficiency ranking index may be pre-calculated so that calculations are not required subsequent to an affirmative outcome of conditional step 825.

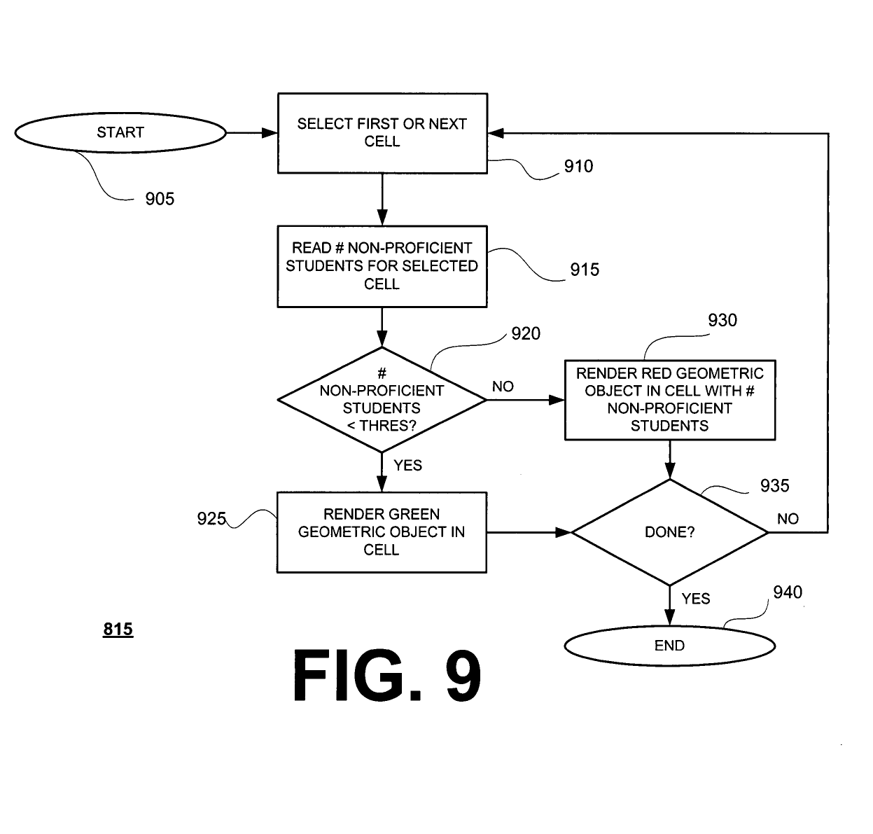

FIG. 9 is a flow diagram of a process for presenting data, according to an embodiment of the invention. The process illustrated in FIG. 9 is an embodiment of display generation step 815 shown in FIG. 8.

As shown in FIG. 9, the process starts in step 905, then is promoted to step 910 to select a first cell. The process then advances to step 915 to read a number of non-proficient students for the selected cell. Next, in conditional step 920, it is determined whether the number of non-proficient students is less than a pre-determined threshold. The pre-determined threshold may be specified, for example, by an AYP goal. Where the determination of conditional step 920 is in the affirmative, the process advances to step 925 to render a green geometric object in the cell. However, where the determination of conditional step 920 is in the negative, the process advances to step 930 to render a red geometric object in the cell with the number of non-proficient students superimposed on the red geometric object. After either of steps 925 or 930, the process advances to conditional step 935 where it is determined whether the rendering process is done. The rendering process may be done, for example, where all cells in a table have been rendered. Where the outcome of conditional step 935 is in the negative, the process returns to step 910 to select a next cell and repeat the subsequent steps. Where all cells have been rendered, the outcome of conditional step 935 will be in the affirmative, and the process ends in step 940.

Variations to the process shown in FIG. 9 are possible. For example, instead of rendering objects in steps 925 and 930 that are distinguishable by color, rendering steps 925 and 930 could render geometric or other objects that are distinguishable according to shape. For example, a round circle could be used to signify that a predetermined target has been met, and a octagon could be used to signify that a predetermined target has been not been met, in the alternative or in combination with color queues. In addition, although FIG. 9 indicates that each cell is processed sequentially, processing could be executed en masse instead of by cell. For example, steps 915 and 920 could be executed for all cells in a table. Moreover, where FIG. 9 illustrates rendering the number of non-proficient students in step 930, in the alternative, the number of students needed to meet the AYP goal could be superimposed on the geometric object in rendering step 933. Furthermore, instead of rendering geometric objects in steps 925 and 934 for display, objects could be rendered for print output.

Method for Calculating and Using a Student Proficiency Ranking Index (SPRI)

The following description provides the motivation, and exemplary embodiments, for calculating a student proficiency ranking index in step 830 of FIG. 8. Various uses of the index data are also disclosed.

Most states do not use a single test instrument or “publisher” across all grade levels. For example, a district may use the Stanford-9 test in grades 2, 4, and 6, and a state-referenced test in grades 3 and 5. Consequently, gauging the extent to which a student has grown over time is difficult as different tests have not been placed on a single score continuum. In order to efficiently target resources, administrators need a means to understand students' relative proximity to proficiency across grade levels and therefore across diverse testing instruments.

In cases where a district is using the same testing instrument for all grade levels, cross grade comparisons are possible using scaled scores (assuming the test has been vertically scaled). However, when different testing instruments are used for different grade levels, comparing scores on different tests is not a meaningful comparison for at least three reasons. First, scaled scores are test-specific. Second, different tests include different content and therefore assess different skills. Last, Normal Curve Equivalents (NCEs) and percentiles are set using specific reference groups, which may differ given the sampling design of the test. Therefore these scores are also not comparable across different tests.

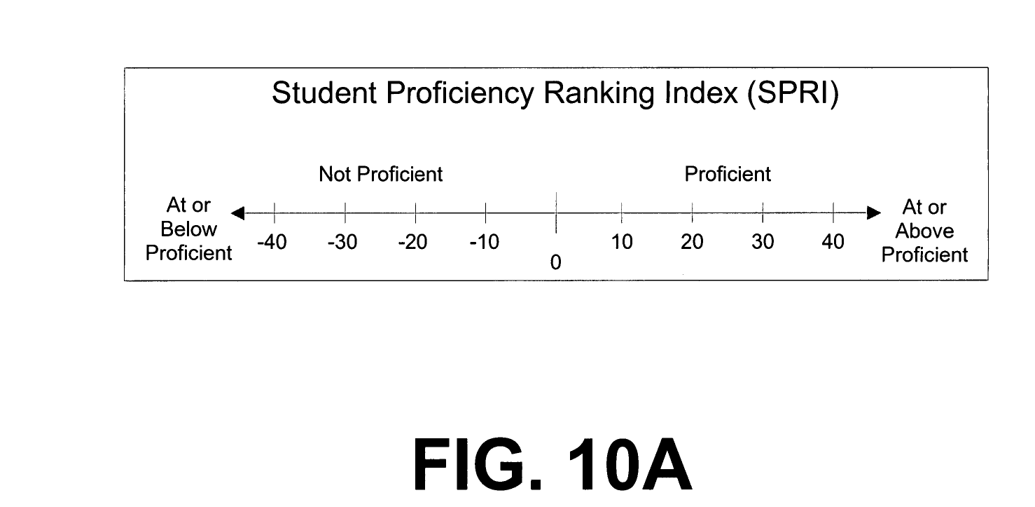

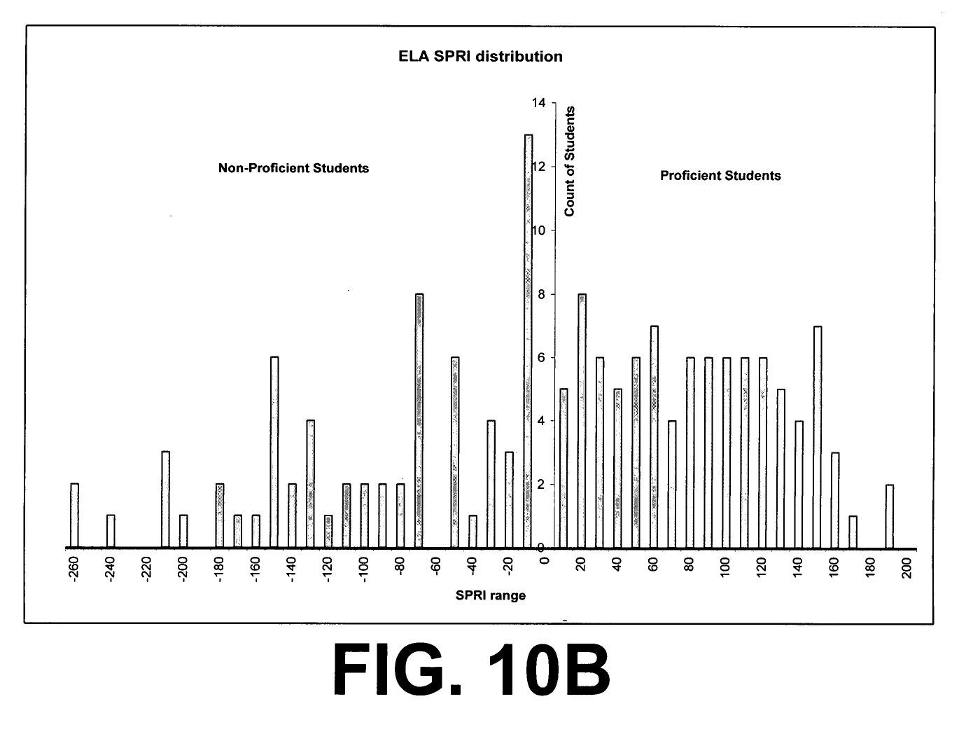

FIG. 10A is a schematic diagram of a data index, according to an embodiment of the invention. In lieu of expensive equating studies, a proxy measure is needed to permit relative comparisons across different testing instruments. The Student Proficiency Ranking Index (SPRI), illustrated in FIG. 10A serves to solve this problem. The SPRI provides a statistical means for comparing student performance against the minimum proficiency level across testing instruments, and therefore grade levels as well. A SPRI score of zero (0) always equals the minimum score for proficiency regardless of the test used. All SPRI scores greater than zero (positive) indicate that the student is (at least) proficient and all SPRI scores less than zero (negative) indicate that the student has not yet reached the proficient cut point. By comparing the SPRI scores of a group of students, an administrator can determine which student is furthest from proficiency based on the relative value of their SPRI scores; the student with the lowest score represents the student furthest from proficiency. This applies to students who not only took the same test but to students who took different tests.

Using the model displayed in Equation 1 below, we compute the distance a student is from the proficiency standard on each respective test, we refer to this as the Student Proficiency Ranking Index, or the SPRI score.

$$SPRI = [ \frac{{y}_{ijkm} - {δ}_{jkm}}{{σ}_{jkm}} ] * 100 \qquad ( 1 )$$

Where:
yᵢⱼₖₘ=The observed scale score for the student i on test j, in subject k in Grade m;
δⱼₖₘ=Is the scale score corresponding to the lower bound cut score for proficiency on test j in subject k in Grade m; and
σⱼₖₘ=Is the standard deviation obtained from the table of norms for test j in subject k for Grade m.
Formally, Equation 1 converts the proficiency scale score into a z-score and subtracts this from the student's observed z-score. Before transformation, this expresses the distance from proficiency in standard deviation units. However, standard deviation units are difficult to interpret. Therefore, the SPRI score is transformed from standard deviation units to one that does not include decimals by multiplying the result by 100. This produces a standardized metric that will allow for direct comparisons across different tests.

The SPRI metric can be used to compare how far Student A is from the proficiency cut point on Test X and how far Student B is from the proficient cut point on Test Y. The metric also has an interval unit property allowing for it to be used in algebraic operations, such as computing averages.

Although the SPRI score metric provides the basis for relative comparisons across different testing systems, it does not account for test difficulty. That is, it may be easier to make progress on Test A than it is on Test B. As a result, students participating on Test A may make progress towards the proficiency standard more quickly than students on Test B. In the case of this scenario, one may incorrectly infer that School A (taking Test A) is more effective than School B (taking Test B) because students have made more progress towards the proficiency standard. However, this is a function of test difficulty (or, in this case, easiness) and not a function of instructional quality.

Individual student remediation and instructional diagnosis determinations will still require the source test. The SPRI score does not imply that two students with the same SPRI score from different tests should have the same instructional diagnosis. This can be a problem when separate tests are aligned more closely to curricular goals. For example, Test A may be aligned well to its respective state standards. Test B may also be aligned well to its respective state standards (different state than Test A). As a result, each test may be measuring different curricular goals. Therefore, students with the same SPRI score from the different tests may not need the same curricular and instructional supports.

The SPRI can guide an administrator or instructor to determine the magnitude and relative dispersion of students who are not proficient, but the underlying test should still be used to determine specific intervention and remediation strategies for each student.

As an example, assume the following data from two tests (Test X for Fourth Grade Math and Test Y for Fifth Grade Math) administered across a given district to calculate the SPRI. Test X administered to fourth graders in Math had a scaled score mean of 420, where as Test Y had a mean scaled score of 550 for fifth graders. The within-group sample standard deviation for Test X was 30 compared to 35 for Test Y. The proficiency cut point for Test X was at 405 scaled score points; all students at or above 405 scaled score points would be deemed proficient. For Test Y, the proficiency cut point was 530.

We will look at three different students. Student A and B, both fourth graders, took Test X and scored a 380 and 410 respectively. Student C is a fifth grader and scored a 525 on her test.

TABLE 1
Sample test score data and SPRI calculations

| | | Student A | Student B | Student C |
|---|---|---|---|---|
| | For- | Test X | Test X | Test Y |
| | mula | (4^{th} Grade) | (4^{th} Grade) | (5^{th} Grade) |
| Mean | \overline{y}ⱼₖₘ | 420 | 420 | 550 |
| Scaled | | | | |
| Score | | | | |
| Within- | σⱼₖₘ | 30 | 30 | 35 |
| group | | | | |
| sample | | | | |
| standard | | | | |
| deviation | | | | |
| Scaled | δⱼₖₘ | 405 | 405 | 530 |
| score cut | | | | |
| point for | | | | |
| proficiency | | | | |
| Student's | yᵢⱼₖₘ | 380 | 410 | 525 |
| scaled | | | | |
| score | | | | |
| SPRI | | −83 | 17 | −14 |

We plug the data for Student A above into equation 1.

$$SPRI = [ \frac{380 - 405}{30} ] * 100$$

$$SPRI = [ .833 ] * 100$$

$$SPRI = - 83$$

(Rounded to the nearest integer)

Looking across the two tests, we can see that Student C (SPRI=−14) is closer to proficiency as measured by Test Y than Student A (SPRI=−83) was on test X. FIG. 10B is a graphical illustration of a data distribution, according to an embodiment of the invention.

Properly understood, the SPRI can help administrators differentiate between students who are closer to proficiency than others students so that intervention strategies can be tailored accordingly. Those students who are significantly further from proficiency will require more systemic intervention (e.g., reading specialists, after school programs, curricular modifications) to ensure that their educational progress is addressed appropriately. An analysis of the SPRI for each student in an entire school building can quantify the magnitude of the challenge that a school might face in ensuring that all students reach proficiency. Analyzing SPRI scores can help prioritize remediation strategies so that dollars are effectively allocated to programs that best suit individual student needs. Implementing a regimen of differentiated remediation strategies may be most effective both academically and financially, in moving toward achieving and surpassing AYP goals.

The SPRI is highly applicable in efforts to compare tests results across state lines. Using the SPRI score, it is possible to make relative comparisons about student performance even though the tests are different. This can help evaluate curriculum and programs deployed across multiple states.

The SPRI can also be applied longitudinally on an individual student to effectively measure student performance growth year over year. Many districts administer tests to students each year, however, as mentioned earlier, the same assessment instrument is rarely administered every year, making it difficult to monitor student progress on an annual basis. The SPRI can be used to plot a student's relative proximity to proficiency year over year, based on the results of different instruments.

The SPRI provides a unique lens for comparing student performance across tests instruments to build a more complete view of student and school performance.

In one embodiment, using a student's SPRI score for a given subject (e.g., Math) one can see the relative growth towards proficiency across two different test instruments administered in different years. This will aid teachers and administrators in evaluating if a student made progress towards proficiency even though the student remained in the non-proficient score group.

TABLE 2
SPRI Growth - comparison of a student's
SPRI scores across two years

| | Test X | Test Y |
|---|---|---|
| | (4th Grade) | (5th Grade) |
| Scaled Score | 380 | 525 |
| Score Group | Not Proficient | Not Proficient |
| SPRI | −83 | −14 |

This student grew by 69 SPRI points from 4th grade to 5th grade. While this student has remained in Not Proficient score group, it can be concluded that the student has improved from the 4th grade to the 5th grade.

In another embodiment, using a student's SPRI score, a teacher or administrator can compare the relative performance of a single student against the mean SPRI score for a cohort of students. For example, an administrator might want to know the relative proficiency for all students of a particular demographic group compared to a single student from that group to evaluate how the student performed relative to his or her peers across grade levels or test years.

TABLE 3
Comparison of Student A's SPRI score
against Group F mean SPRI score

| | Student A | Group F |
|---|---|---|
| | Test X | Test X and Y |
| | (4th Grade) | (4th and 5th Grade) |
| Scaled Score | 380 | |
| Score Group | Not Proficient | |
| SPRI | −83 | Mean = 10 |

Based on this student's performance on the 4th grade test, this student has performed 93 SPRI points below the mean of his peers.

In another embodiment, an administrator can compare the mean SPRI scores of a defined set of students (cohort) across different years or tests to ascertain relative growth between the tests. Combined with the example above of comparing a student's SPRI to a group's mean SPRI, an administrator can compare the relative change in SPRI between the group's mean SPRI and the student's SPRI across the two tests to ascertain if the student had progressed at a faster or slower rate than the cohort.

TABLE 4
Comparison of Student

| | Test X | Test Y | Growth |
|---|---|---|---|
| | (4th Grade) | (5th Grade) | in SPRI |
| Student A | −83 | −14 | 69 |
| SPRI | | | |
| Group F | 10 | 18 | 8 |
| mean SPRI | | | |

While this student was Not Proficient on both the 4th and 5th grade test, this student is demonstrating growth at a rate almost 9 times that of mean growth of his peers.

In yet another embodiment, an administrators can compare relative performance of one cohort against another cohort based on the cohort's respective mean SPRI scores. In the case of NCLB categories, an administrator can compare the relative mean SPRI of one category against the relative proficiency of another (e.g., male versus female). Over time, administrators can use this comparison to determine if particular programs or strategies have been more or less effective with particular groups of students.

TABLE 5
Comparison of Cohort Growth

| | Test X | Test Y | Growth |
|---|---|---|---|
| | (4th Grade) | (5th Grade) | in SPRI |
| Group A | −83 | −14 | 69 |
| mean SPRI | | | |
| Group F | 10 | 18 | 8 |
| mean SPRI | | | |

Sample Analysis 5: While the mean SPRI scores of both Group A and F are Not Proficient, Group A demonstrated a growth rate nearly 9 times as fast as that of Group F.

In another embodiment, teachers can use the SPRI score from the same student across two different subjects to gain a quick understanding of the student's relative strength or weakness in one subject versus the other. While the SPRI will not provide detail as to the student's ability on more granular curricular areas, it would enable observations such as, Student A is relatively stronger in math than in reading, or, Student A is making more progress in reading than in math. This spread in proficiency can then be tracked over time to see if the student is able to close the gap by reaching parody in proficiency in both subjects.

TABLE 6
Comparison of Student Growth by Subject

| | Test X | Test Y | Growth |
|---|---|---|---|
| | (4th Grade) | (5th Grade) | in SPRI |
| Student A | 10 | 15 | 5 |
| Math SPRI | | | |
| Student A | −50 | −25 | 25 |
| ELA SPRI | | | |

This student, while Proficient in Math and not in ELA, is demonstrating greater growth in ELA, at a rate five times that of his growth rate in Math.

Thus, the Student Proficiency Ranking Index (SPRI) is a useful means of distilling disparate and unconnected test data into a simplified view of relative student proximity to proficiency. Administrators and teachers can use SPRI scores to better understand the distribution of students within and between performance levels across tests and grade levels to best plan a course of remediation and instruction that addresses the specific level of needs of a group of students. Administrators and teachers can use SPRI Growth to monitor the progress of individual students, cohorts, or institutions in order to best understand needs and effectively deploy resources.

FIG. 11 is an illustration of a data presentation, according to an embodiment of the invention. FIG. 11 is an embodiment of a data presentation at level 235 as illustrated in FIG. 2. FIG. 11 is also exemplary of the type of detailed student data that can generated by display steps 830 and 835 in FIG. 8. In a preferred embodiment, the students listed are a sub-set of all students, based on the selection of a particular cell in step 825.

As shown in FIG. 11, a data presentation includes a student name column 1105 and a SPRI column 1110. FIG. 11 also illustrates that student data may be sorted according to proximity to goals (e.g., according to the SPRI) for comparison purposes.

Miscellaneous Reporting Formats and Methods

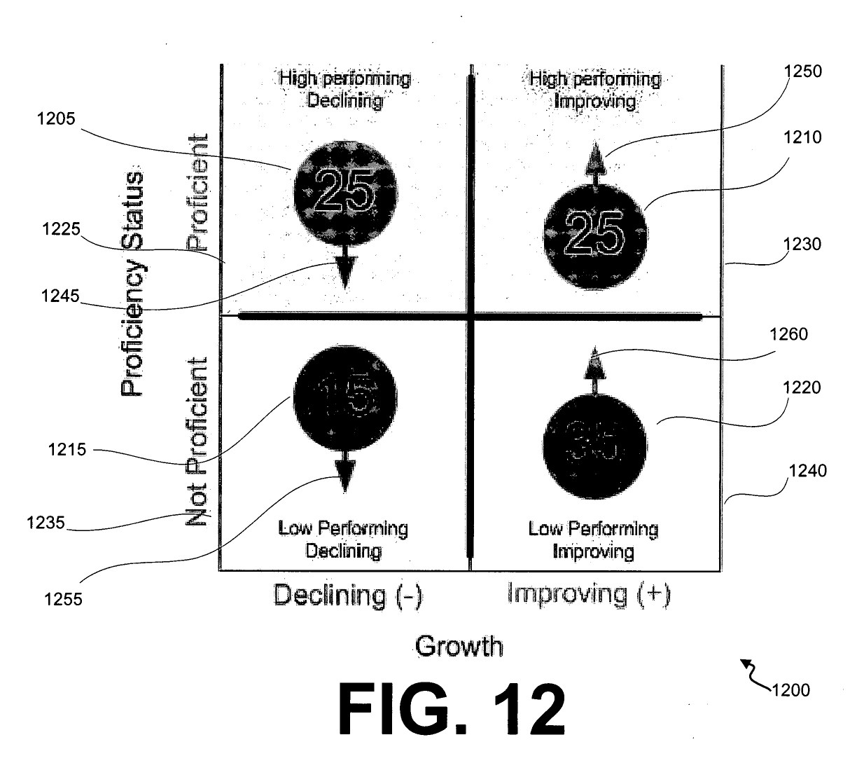

FIG. 12 is an illustration of a data presentation, according to an embodiment of the invention. FIG. 12 shows growth (or trending) information where, for example, performance against AYP goals are compared on a year-to-year basis. As shown therein, the summary data table 1200 is partitioned into four quadrants, 1225, 1230, 1235 and 1240. In each of the quadrants, data are represented, in part, by a geometric objects 1205, 1210, 1215, and 1220. Each of the geometric objects (icons) 1205, 1210, 1215, 1220 may be represented, for example, in different colors to reflect a feature of the data they represent. For example, inasmuch as quadrants 1235 and 1240 represent data indicating non-proficiency, geometric objects 1215 and 1220 may be indicated in red color. Likewise, inasmuch as quadrants 1225 and 1230 represent proficient data, geometric objects 1205 and 1210 may be represented in green color.

Advantageously, the representations in FIG. 12 also indicate trend information by the use of arrows 1245, 1250, 1255 and 1260 that are part of icons 1205, 1210, 1215, and 1220, respectively. The direction of the arrows are illustrative of growth year-to-year. For example, inasmuch as quadrants 1235 and 1225 represent a decrease in proficiency, geometric objects 1205 and 1215 are appended with downward-pointing arrows 1245 and 1255, respectively. In addition, inasmuch as quadrants 1230 and 1240 represent improved results, geometric objects 1210 and 1220 are appended with upward-pointing arrows 1250 and 1260, respectively.

Accordingly, as illustrated in FIG. 12, both the placement of the icons 1205, 1210, 1215, and 1220, and the visual appearance of the icons 1205, 1210, 1215, and 1220 represent two features of the underlying data. One feature is static (proficiency or non-proficiency in the later time period); the feature is dynamic, or comparative (whether proficiency has declined or improved with respect to a prior time period).

A method for producing the presentation illustrated in FIG. 12 is similar to the process illustrated and described above with reference to FIG. 9. For example, a method for generating the table 1200 illustrated in FIG. 12 for multiple students in a predetermined subject area, showing growth (differences) between a first time period data (e.g., test scores in month X) and a second time period data (e.g., test scores in month Y) could include:
Step 1: determine whether each student is proficient in the second time period based on a comparison of the second time period data and a predetermined target;
Step 2: determine whether each student improved in proficiency based on a comparison of the first time period data and the second time period data;
Step 3: render a chart with four quadrants (as illustrated in FIG. 12);
Step 4: render an icon in each of the four quadrants, using green for icons in the two proficient quadrants, red for the two icons in the two not proficient quadrants, up arrows for the two icons in the improving quadrants, and down arrows for the two icons in the declining quadrants; and
Step 5: superimpose numbers on each of the icons, where the numbers represent the number of students in the group associated with the status of each corresponding icon. For instance, if each of 6 students were proficient in the second time period and also improved their proficiency over the first time period, then a number 6 could be placed on the icon that is green in color with an up arrow.

Of course, variations are also possible for generating a growth chart. For example, quadrants are not necessarily required, since visual properties of the icons themselves can provide both proficiency and trending information. In addition, the visual properties need not include the colors green and red as indicated above; other visual queues may be used. Superimposed numbers are also optional. Moreover, in similar fashion to the process described with reference to FIG. 8, selection of any of the icons in FIG. 12 could hyperlink a user to more detailed data associated with the selected icon. Further, although the numbers in icons 1205, 1210, 1215, and 1220 have been described in Step 5 above as relating to a quantity of students, the numbers could alternatively represent a quantity of schools, a quantity of teachers, or other parameter (e.g., according to level of reporting hierarchy).

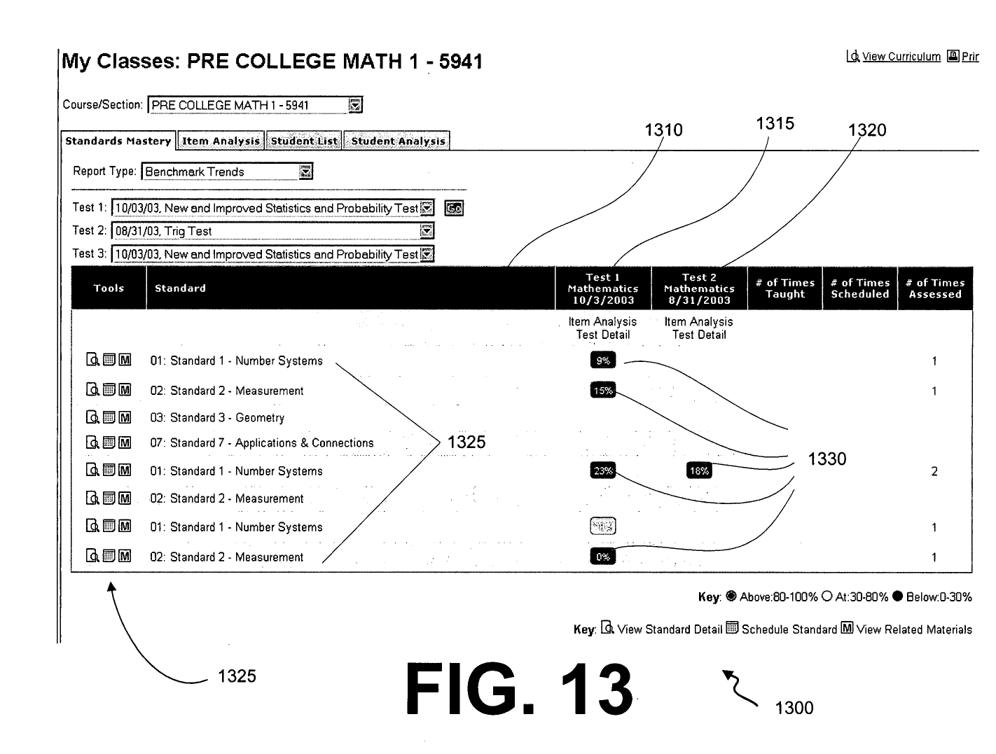

FIG. 13 is an illustration of a data presentation, according to an embodiment of the invention. As shown in FIG. 13, a table 1300 can be presented using standard column 1310 and test result columns 1315 and 1320. Rows 1325 represent individual standards within a predetermined subject area of study (e.g., within the subject of pre-college math, as illustrated). Cells 1330 indicate performance on certain tests results 1315 and 1320 for particular standards 1325. As indicated, not all standards may be tested in all tests. Cells 1330 may indicate an overall proficiency, for example with regard to the color rendered. Additionally, cells 1330 may indicate a level of proficiency via numbers superimposed on the icons of cells 1330.

In a preferred embodiment, table 1300 includes tools column 1325. Tools column 1325 can be used in an education process workflow. For example, with reference to table 1300, a teacher or other user could identify that instructional plans may need to be bolstered for teaching “Number Systems” and “Measurement,” standards, since cells 1330 indicate that proficiency for those subject areas on Test 1 is 9% and 0%, respectively. Tools column 1325 provides links to resources which can aid the teacher or other user in modifying instructional plans in the identified subject areas.

Functional Architecture

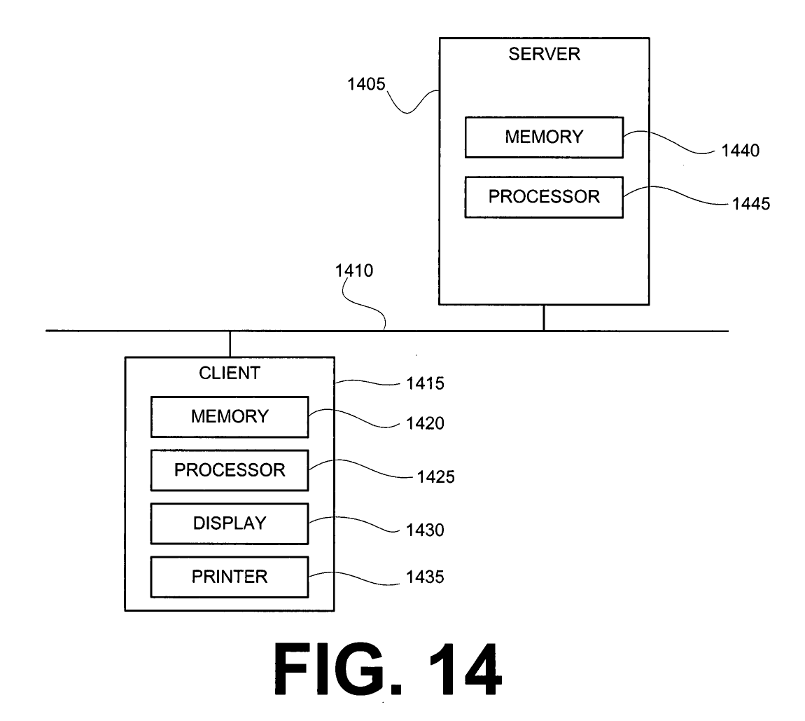

FIG. 14 is a block diagram of a functional architecture, according to an embodiment of the invention. As shown in FIG. 14, a server 1405 is in communication with a client 1415 via a link 1410. The client 1415 further includes memory 1420, processor 1425, display 1430, and printer 1435. Server 1405 may also include a memory 1440 and a processor 1445. Client 1415 may be or include, for example, a personal computer, a PDA, a Web-enabled phone, or other client device. Moreover, link 1410 may be a LAN, a WAN, the Internet, or other wired or wireless network.

Any of the processes described herein may be implemented in hardware, software, or a combination of hardware and software. In a software implementation, the software may be stored on memory 1440 and/or memory 1420. In addition, software in memory 1440 and/or memory 1420 may be readable by processor 1445 and/or processor 1425 to execute the processes described herein. In one embodiment, data is stored in memory 1440, the software is stored in memory 1420, and processor 1425 reads code from memory 1420 to execute the processes described herein. In an alternative embodiment to what is shown in FIG. 14, one or more processes are executed on a stand-alone computer or on a similar device that has a processor and memory. In embodiments of the invention, the graphical presentations described herein may be presented on a computer monitor or other display; alternatively, or in combination, the graphical presentations described herein may be printed in hard copy format.

### CONCLUSION

In conclusion, embodiments of the invention provide, among other things, a system and method for data analysis and presentation. Those skilled in the art can readily recognize that numerous variations and substitutions can be made to-the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims. For example, in practicing the invention, the icons may have visual characteristics not illustrated in the Figures. Furthermore, the invention is applicable to industries and endeavors other than education. In addition, although references are made to embodiments of the invention, all embodiments disclosed herein need not be separate embodiments. In other words, features disclosed herein can be utilized in combinations not expressly illustrated.

1. A method for presenting data, comprising:
displaying a first table, the first table including at least one column, at least one row, and at least one icon, each of the at least one icons associated with one of the at least one column and one of the at least one row, at least one of the icons being numbered;
determining whether a user selects a numbered one of the at least one icons; and
if the user selects a numbered one of the at least one icons, displaying a second table based on the column and the row associated with the selected one of the at least one icon.

2. The method of claim 1, wherein displaying includes rendering a characteristic of the at least one icon to represent a feature of the content of the second table.

3. The method of claim 2, wherein the characteristic is at least one of size, shape, and color.

4. The method of claim 1, wherein displaying a second table includes calculating a student proficiency ranking index for each of a plurality of students associated with the selected one of the at least one icon, the student proficiency ranking index corresponding to a deviation from a predetermined proficiency standard.

5. A method for displaying assessment data, comprising:
displaying a first portion of the assessment data for at least one subject area and at least one demographic category, displaying including rendering a plurality of icons, each of the plurality of icons associated with one of the at least one subject area and one of the at least one demographic category, at least one of the plurality of icons incorporating a number associated with a quantity of students;
determining whether a user selects a numbered icon; and
if the user selects a numbered icon, displaying a second portion of the assessment data corresponding to the quantity of students.

6. The method of claim 5, wherein the at least one demographic category includes at least one of gender, race, ethnicity, special education, special education, socio-economic, migrant, and limited English proficiency status.

7. The method of claim 5, wherein rendering includes selectively rendering the at least one icon in at least one of green and red, green indicating that a predetermined proficiency goal has been met for the associated subject area and demographic category, red indicating that the predetermined proficiency goal has not been met for the associated subject area and demographic category.

8. The method of claim 5, further comprising calculating a student proficiency ranking index for each of a plurality of students, the second portion of the assessment data including the student proficiency ranking index for each of the plurality of students, the student proficiency ranking index corresponding to a deviation from a predetermined proficiency standard.

9. A method for displaying student performance data, the data including for each of a plurality of subjects an indication of whether the student has achieved proficiency, the data organized into cells, each cell including data for a plurality of students, comprising:
determining the total number of non-proficient students associated with the cell;
determining whether the total number of proficient students is less than a predetermined threshold for the cell;
if the total number of non-proficient students is less than the predetermined threshold, rendering a first icon for the cell; and
if the total number of non-proficient students is not less than the predetermined threshold, rendering a second icon for the cell, the second icon having at least one numeric character superimposed thereon.

10. The method of claim 9, wherein the at least one numeric character represents the total number of non-proficient students for the cell.

11. The method of claim 9, further comprising determining a difference between the total number of non-proficient students for the cell and the predetermined threshold for the cell, the at least one numeric character being the difference.

12. A method for generating a growth chart for a plurality of students in a predetermined subject, the growth chart based on first time period data and second time period data for each of the plurality of students, the method comprising:
for each of the plurality of students, determining whether they have proficient status based on a comparison of the second time period data and a predetermined target;
for each of the plurality of students, determining whether they have improving status based on a comparison of the first time period data and the second time period data;
rendering a chart, the chart having a first quadrant corresponding to proficient status and improving status, a second quadrant corresponding to non-proficient status and non-improving status, a third quadrant corresponding to proficient status and non-improving status, and a third quadrant corresponding to non-proficient status and improving status; and
rendering one of a plurality of icons in each of the first quadrant, the second quadrant, the third quadrant, and the fourth quadrant, each of the plurality of icons having a first visual characteristic associated with a proficiency status and a second visual characteristic associated with improvement status.

13. The method of claim 12, wherein the first visual characteristic is a color and the second visual characteristic is a directional arrow.

14. The method of claim 12, wherein each of the plurality of icons has at least one numeric character superimposed thereon, the at least one numeric character representing the quantity of students associated with one of the first quadrant, second quadrant, third quadrant, and fourth quadrant.

15. A method for calculating a first student proficiency ranking index for a first student, on a first test, in a first subject, in a first grade, comprising:
determining a raw test score on the first test;
converting the raw test score to a first observed scale score;
determining a lower bound scale score for proficiency for the first test;
determining a standard deviation for the first test;
subtracting the lower bound scale score for proficiency for the first test from the first observed scale score to produce a first difference value; and
dividing the first difference value by the standard deviation for the first test to produce a first standard deviation unit.

16. The method of claim 15, further comprising multiplying the first standard deviation unit by 100 to produce the first proficiency ranking index.

17. The method of claim 15, further comprising:
calculating a second proficiency ranking index for the first student, on a second test, in the first subject, in the first grade; and
averaging the first proficiency ranking index and the second proficiency ranking index to produce an average proficiency ranking index for the first student, in the first subject, in the first grade, wherein calculating the second proficiency ranking index includes:
determining a raw test score on the second test;
converting the raw test score to a second observed scale score;
determining a lower bound scale score for proficiency for the second test;
determining a standard deviation for the second test;
subtracting the lower bound scale score for proficiency for the second test from the second observed scale score to produce a second difference value; and
dividing the second difference value by the standard deviation for the second test to produce a second standard deviation unit.

18. A machine readable medium having instructions stored thereon for execution by a processor to perform a method comprising:
displaying a first table, the first table including at least one column, at least one row, and at least one icon, each of the at least one icons associated with one of the at least one column and one of the at least one row, at least one of the icons being numbered;
determining whether a user selects a numbered one of the at least one icons; and
if the user selects a numbered one of the at least one icons, displaying a second table based on the column and the row associated with the selected one of the at least one icon.

19. A machine readable medium having instructions stored thereon for execution by a processor to perform a method comprising:
displaying a first portion of the assessment data for at least one subject area and at least one demographic category, displaying including rendering a plurality of icons, each of the plurality of icons associated with one of the at least one subject area and one of the at least one demographic category, at least one of the plurality of icons incorporating a number associated with a quantity of students;
determining whether a user selects a numbered icon; and
if the user selects a numbered icon, displaying a second portion of the assessment data corresponding to the quantity of students.

20. A machine readable medium having instructions stored thereon for execution by a processor to perform a method comprising:
determining a raw test score on the first test;
converting the raw test score to a first observed scale score;
determining a lower bound scale score for proficiency for the first test;
determining a standard deviation for the first test;
subtracting the lower bound scale score for proficiency for the first test from the first observed scale score to produce a first difference value; and
dividing the first difference value by the standard deviation for the first test to produce a first standard deviation unit.
